(19) United States
(12) Patent Application Publication
(10) Pub. No.: US 2020/0146279 A1
(43) Pub. Date: May 14, 2020

(54) Active Attachment for Water Fowl Decoy

(71) Applicant: Kevin Rhett Young, Madison, MS (US)

(72) Inventor: Kevin Rhett Young, Madison, MS (US)

(21) Appl. No.: 16/730,929

(22) Filed: Dec. 30, 2019

Related U.S. Application Data
(63) Continuation-in-part of application No. 15/133,412, filed on Apr. 20, 2016, now Pat. No. 10,517,290.
(60) Provisional application No. 62/151,178, filed on Apr. 22, 2015.

(51) Int. Cl. A01M 31/06

(52) U.S. Cl. CPC A01M 31/06

(57) ABSTRACT

A motion attachment device designed to be attached to the keel of a decoy includes a housing or frame that is configured to releasably receive the keel. An actuator coupled to one or more appendages that are attached to the housing or frame to move the one or more appendages to impart a realistic motion to the decoy. The same motion attachment device can be attached to different decoys at different times and can be used with a variety of interchangeable appendages to simulate at least one of a swimming motion, a wing flapping motion, bobbing motion, and feeding motion.

### REFERENCE TO RELATED APPLICATIONS

This application is a Continuation in Part of U.S. Ser. No. 15/133,412 filed Apr. 20, 2016, which claims priority to U.S. 62/151,178 filed Apr. 22, 2015.

### BACKGROUND OF THE INVENTION

### Field of the Invention

This invention relates to a device for attachment to a waterfowl decoy, and associated method, to impart a realistic movement to the combined attachment and decoy.

### Description of Related Art

Hunting for waterfowl such as ducks and geese often involves the the placement of decoys on the water's surface to attract flying waterfowl and cause them to land on the water near decoys. Static decoys made of wood or plastic, for example, have no moving parts and function to attract over flying waterfowl by having the visual appearance of waterfowl calmly floating on the water. Active decoys have at least one moving part that imparts a motion to the decoy. For example, an active decoy may have a battery powered motor attached to a propeller to move the decoy on the water. An active decoy may have a motor attached to wings to mimic the visual appearance of flapping wings. While active decoys are generally considered to be more effective than static decoys, active decoys are much more expensive and complex than passive decoys and each active decoy represents only one species of waterfowl. As a consequence of the high cost, most hunters do not purchase a “flock” of active decoys, especially if they already own a number of static decoys, and hunters may be limited in the variety of active decoys they have as well.

US 2016/0309704 to Young solves the problem of expensive and complex active decoys by providing a motion attachment device that can reversibly attach to a keel of any of a variety of static decoys. The motion attachment device has a motor that can move an appendage, such as an artificial foot or artificial wing, to create a realistic motion for attracting waterfowl. While the attachment device is relatively easy to use and provides improvements with respect to cost, realistic motion, and versatility, further improvements are desired.

US 2015/0313207 to Anson solves a problem with decoys related to their use on land as well as on water by providing a decoy that can be configured for use on water or dry land. The decoy includes a keel for stabilizing the decoy while in water and a leg support with a base member that can be removably secured to the leg support to stabilize the decoy device on dry land. The keel and leg support are for the same decoy, and not interchangeable between different static decoys representing different species of waterfowl.

U.S. Pat. No. 5,775,022 to Sumrall solves problems associated with the propulsion mechanisms used with keeled active decoys by providing a self-propelled keel-less decoy that does not get hung up in debris. The decoy has a base with a propulsion system that provides a reciprocating motion to mimic the swimming motion of a duck or goose, for example. The base is reversibly attached to the bottom of a shell that sits above the water and looks like a particular species of waterfowl.

A number of improvements have been made to static and active decoys but a need in the art remains for further improvements to attachments for decoys, including improvements in the interchangeability and ease of use of devices for attachment to static and active decoys, and improvements to the realistic movements imparted by decoy attachments to the decoy-attachment combination.

### BRIEF SUMMARY OF THE INVENTION

The present invention provides further improvements to devices that are attached to static and optionally active waterfowl decoys. A decoy motion attachment device for use with a separate animal decoy comprises a frame or housing removably mountable to the animal decoy and at least one motor inside a water tight casing coupled to the frame or housing. At least one simulated animal appendage may be coupled to the motor to actuate movement of the simulated appendage. With this construction, the decoy motion attachment device may be mounted and dismounted from the animal decoy and at least one motor provides motion to the at least one animal appendage.

The device is preferably configured to be reversibly attached to the keel of a waterfowl decoy comprising a keel. A kit comprising the device may comprise an adapter to improve the fit of the keel into a keel receiving portion of the device, a battery, a carrying case, a remote control transmitter, and/or a keel or keel alternative for reversible attachment to a decoy lacking a keel.

Appendages may include simulated feet, simulated wings, a propulsion means for simulating swimming movement of the decoy, and/or a weight or pump and ballast system for simulating a feeding position and/or movement. Further aspects of the invention are described in detail below.

A system for attracting waterfowl or other game birds may comprise a motion attachment device and a remote control device for controlling the operation of the motion attachment device. A system may additionally or alternatively comprise two or more motion attachment devices equipped with microprocessors and sensors and configured to control movements of attachment device appendages in response to proximities or movements of the devices with each other or interactions between devices and wireless beacons.

### BRIEF DESCRIPTION OF THE DRAWINGS

The elements of the drawings are not necessarily to scale relative to each other, with emphasis placed instead upon clearly illustrating the principles of the disclosure. Like reference numerals designate corresponding parts throughout the several views of the drawings in which:

FIG. 1 is a perspective view of one embodiment of a decoy motion attachment device with a duck decoy received into the device;

FIG. 2 is a bottom view of a decoy motion attachment device without actuators attached;

FIG. 3 is an exploded view of an embodiment of an actuator for a decoy motion attachment device of the type shown in FIG. 1;

FIG. 4 is an exploded, perspective view of an embodiment of a wing portion of a decoy motion attachment;

FIGS. 5a and b are a bottom view and a partial side view of a decoy motion attachment device comprising alternative clamping and actuator attachment mechanisms;

FIGS. 6a and b are a bottom view a partial side view of a decoy motion attachment device comprising alternative keel and actuator attachment mechanisms;

FIG. 7 is a top view of a decoy motion attachment device comprising alternative attachment mechanisms.

FIG. 8 is front view of a decoy motion attachment device comprising a frame with a spring loaded scissor linkage; and

FIG. 9 is is top view of a decoy motion attachment device comprising a frame with a spring loaded scissor linkage.

### DETAILED DESCRIPTION OF THE INVENTION

Selected embodiments are explained with reference to the drawings. It will be apparent from this disclosure that the descriptions of the selected embodiments are provided for illustration only and not for the purpose of limiting the invention as defined by the appended claims and their equivalents.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

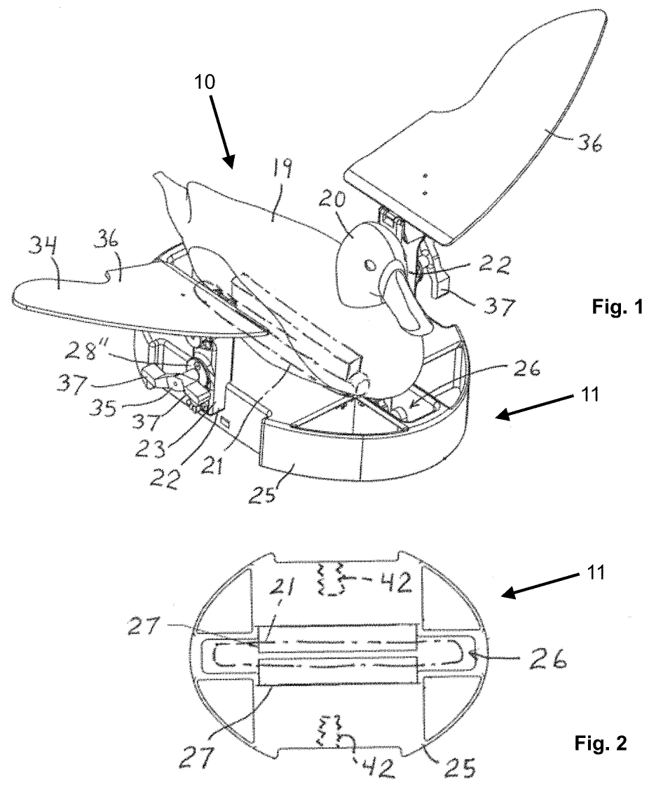

With reference to FIG. 1, there is shown an animal decoy 10 to which a first embodiment of a motion attachment device 11 has been reversibly attached. The animal decoy 10 is shown in the form of a duck, however, it should be understood that other decoys resembling other aquatic animals that swim on the surface of water and especially other waterfowl such as numerous duck and goose species, may be used.

The decoy 10 is a static object that is typically made of a plastic material, wood or composite material and is most often of a hollow plastic or solid wood construction. The decoy 10 in this figure comprises a body section 19, a head section 20 extending from the forward top portion of the body 19, and an elongated weighted keel 21 extending from the bottom side of the body 19 which maintains the decoy in a generally upright orientation when afloat. This type of decoy 10 is designed to resemble a waterfowl floating upright in the water. Other types of decoys, such as those resembling a feeding waterfowl with a feet up, head down orientation may also be used with some embodiments of the motion attachment device 11 as will be described.

The embodiment of the motion attachment device 11 in FIG. 1 is designed to be removably coupled to the keel 21 of the decoy 10 without substantially changing the buoyancy of the decoy. The motion attachment device 11 comprises a frame or housing 25 which is preferably made of a durable plastic material such as polycarbonate, polyethylene, or nylon, and may be made of another suitable material. The frame 25 shown in FIG. 1 comprises an elongated longitudinal slot 26 which is configured to releasably receive the keel 21 in order to mount the motion attachment device 11 to the decoy 10. The slot 26 in this embodiment has a static size and shape that is large enough to receive the keel 21 so that a securing means 27 may be used to reversibly secure the motion attachment device 11 to the keel. Other embodiments comprise a frame 25 comprising portions that move relative to one another to allow different sizes and shapes of the slot 26.

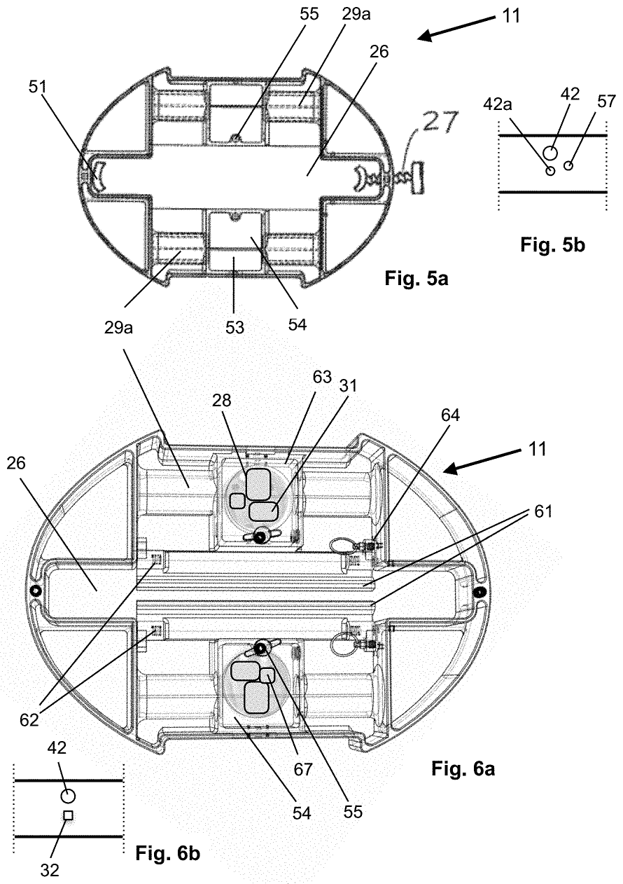

The embodiment shown in FIG. 1 comprises a securing means 27 positioned adjacent to the slot 26 to clamp down upon the keel 21 and thereby reversibly secure the device 11 to the decoy 10. The securing means 27 may be in the form of one or more members which extend parallel to and along one side or opposite sides of the keel 21, and which clamp down upon the keel. Additionally or alternatively, the securing means 27 may comprise a moveable clamp which applies a force one end of the keel 21 and presses the opposite end the keel against the opposite end of the slot 26, which may be comprise a cradle 51 made, for example, of rubber or resilient material to provide a snug fit as shown in FIG. 5 without damaging the keel. Securing means 27 may additionally or alternatively comprise an elastic mounting device such as an elastic band or loop, a threaded set screw, inflatable pneumatic balloons, one or more spring tensioned members attached to the frame 25 applying a force against the keel, portions of the frame 25 that are tensioned to apply a force against the keel, and other suitable reversible securing means.

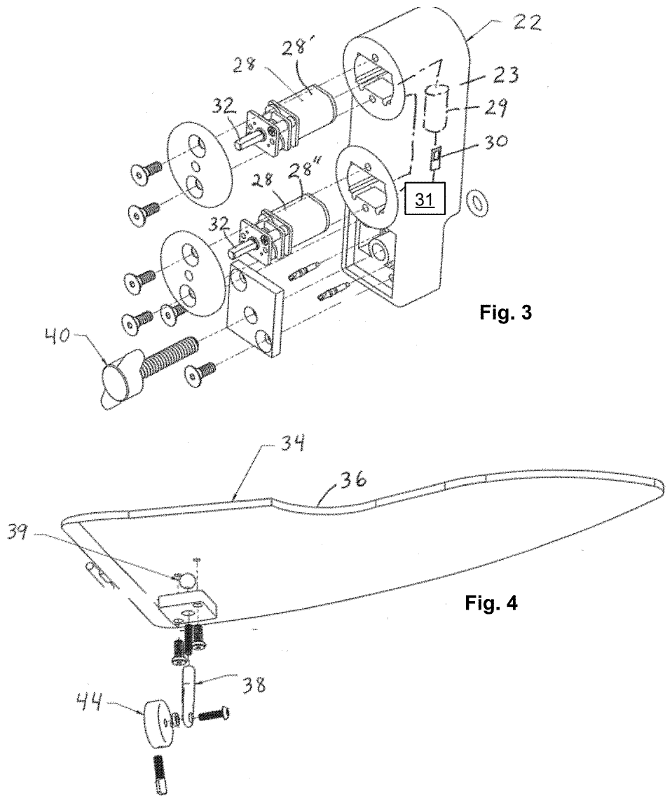

The device 11 shown in FIG. 1 comprises a pair of actuators 22 removably mounted to opposite sides of the frame or housing 25. Each actuator 22 comprises a motor 28 inside a watertight casing 23 with the motor 28 electrically coupled to a battery 29 also inside the casing 23 (FIG. 3). The motor may be controlled using an on/off switch 30 mounted on the casing 23 and connected to the motor, battery circuit. The actuator 22 may additionally comprise a microprocessor 31 programmable to achieve one or more of a time delay in activation of the motor 28, a sequencing of motor activation, a variation in power supplied to the motor, a remote control capability, and reversing of the power from the battery to the motor to reverse the direction of the motor. The actuator may comprise a charging port adapted to recharge a rechargeable battery and/or a removable cover allowing access to the battery for battery replacement.

Referring to the embodiment of an actuator shown in FIG. 3, each actuator 22 comprises two motors 28, a top motor 28′ for driving the movement of the wings and a bottom motor 28″ for driving the movement of the feet, as described in more detail hereinafter. However, it should be understood that as an alternative embodiment, the actuator may include only a single motor for driving either the wings or the feet. In another alternative embodiment, the device 11 may comprise only a single motor 28 mechanically linked to two or more appendages 34.

Each motor 28′ and 28″ comprises, or is connected to, a rotating shaft, axle, socket or post 32 to which a simulated animal appendage 34 may be coupled. The bottom motor 28″ is shown coupled to an appendage 34 in the form of a foot 35 mounted to the motor shaft 32. The foot 35 is in the form of an elongated T-shaped member having two oppositely disposed paddles or ends 37. The actuation of the bottom motor 28″ causes the foot 35 to rotate, thereby causing the duck to move through the water while creating a splashing of the water to resemble an actual duck's movement. Alternatively, the foot may be in the form of a webbed foot member similar to a duck's foot that moves with a reciprocating motion, a propeller, a water pump, a jet pump, or another propulsion means for moving the device 11, and thereby the decoy 10. Depending on the type and number of propulsion means, the propulsion means may be positioned at the sides of the frame 25, centrally in the lateral direction near the center, front or rear of the frame 25, or another desired position. An appendage 34 may be used to generate a water spray in addition to, or as an alternative to, propulsion of the device 11. The fame or housing 25 may be reversibly attached to or comprise an appendage in the form of a propeller, fan, or drone allowing the decoy -device combination 10,11 to simulate landing, take off, and/or hovering motion.

A motion attachment device 11 may comprise an appendage 34 comprising a weight that is moved toward the front end or the back end of the frame to simulate bobbing. If the weight is sufficiently heavy and moved forward of the head of an attached duck decoy 10, for example, the tail end of the decoy 10 may rise out of the water to simulate a feeding motion. A decoy 10 shaped as a back half of a duck sticking out of the water may be attached to a motion attachment device 11 directly using reversible attachment means or, if the decoy does not have a keel 21, a keel may be attached to the decoy and the decoy may be attached to the motion attachment device 11. With such embodiments, the appendages 34 chosen for attachment may be simulated duck feet that move with a reciprocating motion.

The top motor 28′ is shown coupled to an appendage 34 in the form of a simulated duck wing 36 that is hingedly or pivotally mounted to the casing 23 and mechanically coupled to the motor shaft 32 (FIG. 4). The wing may be mounted to the shaft 32 through a linkage extending between the shaft 32 and the wing 36. The linkage comprises a rod 38 and a ball joint assembly 39 coupled to the wing to allow rotational and articulated movement of the rod 38 relative to the wing 36. The rod 38 is coupled to the shaft 32 through a flywheel 44, wherein the connection point of the shaft 38 is offset from the axis of the shaft/flywheel to cause the rod to move vertically through rotational movement of the shaft 32.

Actuation of the top motor 28′ causes the wing 36 to move up and down, thereby causing the combination of the duck decoy and attached motion device 11 to have the appearance of a duck that is preening, drying its wings, or in flight. With either appendage 34, the motor(s) may be actuated to rotate in one direction or rotate back and forth in opposite directions. The electric circuit including the motors and battery may also include motion and sound sensors to initiate actuation of the motors. A remote control device (by radio control, bluetooth, or other wireless protocol) may be used to control the motor 28 through communication with a microprocessor 31 connected to the motor circuit, allowing actuation of the motor, independent actuation of each motor, steering, and/or other controlled movement of the device 11 and thereby the attached decoy 10. Additionally or alternatively, a tether attached to the decoy 10 or device 11 may be used to anchor the combination to the bottom to limit range of movement.

Each actuator 22 in FIG. 1 is self contained and removably mounted to the frame or housing 25 through a threaded bolt 40 extending through a bolt hole in the casing 23 and into a corresponding internally threaded bolt hole 42 in the frame/housing 25. The bolt 40 is preferably hand driven. Additionally or alternatively, the actuator 22 may be reversibly mounted to the frame or housing 25 using other means such as a clamp, quick release connector, magnetic attachment, tape, or an elastic band.

In use, the motion attachment device 11 shown in FIG. 1 is mounted to a decoy 10 by extending the decoy's keel 21 through the slot 26 of the device and securing the device 11 to the keel with securing means 27. With the device 11 secured in place, the combination decoy and device may be place on land or in the water to resemble a real animal which the decoy is imitating. The on/off switch 30 is then actuated to that the battery 29 energizes the motor(s), which in turn actuates the appendage 34 coupled to the motor(s). The motion attachment device 11 may be operated to cause the decoy 10 to move forward, backwards, spin, rotate, flutter the wings, splash the water, move the feet, bob the head, or raise the wings. The operation of the bottom motor 28′ causes the foot 35 to rotate resulting in the paddled movement of the decoy. Similarly, the operation of the top motor 28″ causes the linkage rod 38 to reciprocate resulting in the “flapping” or movement of the wings 36. The decoy may be coupled to legs or to a stand so that it may be utilized on land with the motors actuating the wings.

One advantage of the embodiment shown in FIG. 1 is that any of the actuators 22 may be removed and/or switched with another actuator 22 to provide different combinations of appendage types and/or movement characteristics. To accomplish this, the threaded bolt 40 may be unscrewed from the bolt hole 42 to release the actuator casing 23 from the housing 25. Another advantage is the ability to attach the device 11 to any static decoy 10 comprising a keel 21 that fits into the slot 26. As a result of these advantages, a variety of motions may be associated with any number of different waterfowl decoys to impart a more realistic appearance and attract waterfowl. The ability to attach the device 11 to decoys 10 resembling different species and genders at different times enable a hunter to avoid the need to purchase many different active decoys to attract different species at different times of the year or locations. For example, the device 11 may be utilized with a mallard duck decoy at one time and with a pintail duck, goose, or other type or species of waterfowl decoy at a different time.

Another advantage of the present invention is the ability to interchange, replace or switch different actuators in a quick and easy fashion. For example, if one were to wish to switch from a wing flapping actuator to a foot swimming actuation this can easily be accomplished by unthreading the actuator bolt 40 from the bolt hole 42 thereby removing the actuator from the housing 25 and replacing it with a different actuator.

The decoy shown in FIG. 1 is a static decoy 10. A motion attachment device 11 according to the invention may be attached to an active decoy comprising a motorized mechanism. For example, a motion attachment device 11 may be attached to the keel of an active decoy that, when activated, expands the size or volume of the chest area or uses an attached appendage in the form of a chest so as to simulate the “puffing” or “showing” of an animal, such as the bellowing of a turkey. This may be accomplished with a motor which pushes outwardly upon plates that form the decoy chest.

Referring to FIG. 2, the securing means 27 may comprise a pair of movable elements running in a longitudinal direction along the outer edges of the slot 26 for receiving and engaging the keel 21. The movable elements may comprise a surface having a high coefficient of friction against the keel material and be hinged such that receiving the keel into the slot 26 causes the movable elements to swing open on their hinges and hold the keel 21 in place because withdrawing the keel causes the movable elements to jam against the keel. The keel 21 may be removed by manually pressing the movable elements open wider to release the keel.

FIGS. 5a and 5b show an embodiment of a motion attachment device 11 comprising an alternative configuration to those shown in FIG. 1 and FIG. 2. The device comprises a securing means 27 comprising a means for applying a pressure, or force, to the keel at one end of the slot 26 for receiving the keel 21 and a cradle 51 on the opposite end of the slot 26 for engaging the keel. The means for applying a pressure may comprise, for example, a spring or a threaded screw that can be operated manually to apply and release pressure on the keel 21. The cradle 51 and means for applying a pressure preferably comprise surfaces that are cushioned or elastic to avoid damaging the keel 21. Battery casings 29a for holding batteries 29 are attached to the frame or housing 25 or may be integral with the housing 25. A microprocessor casing 53 on either lateral side of the frame or housing 25 is attached to, or is integral with, the frame or housing 25 and contains a microprocessor 31 connected to the batteries 29. The microprocessor 31 may comprise or be connected to a receiver or transceiver for one way or two way wireless communication with a remote control device. The interior of the microprocessor casing 53 may be accessed by opening a water tight casing cover 54 that is held closed by a fastener 55, such as a screw or latch and may be configured to allow the passage of a battery 29 into the battery casing 29a. The outward facing lateral side of the microprocessor casing 53 may comprise a threaded bolt hole 42 or other securing means such as clips, quick connectors, magnets, clasps, and/or straps for reversible attachment of an actuator 22. A guide hole 42a may be present to receive a post on the actuator to help align and stabilize the actuator 22. An electrical connector 57 connects the actuator 22 to the power supply of the batteries and the control functions of the microprocessor 31.

FIGS. 6a and 6b show another embodiment of a motion attachment device 11 comprising alternative attachment and actuation features. The device 11 comprises a pair of hinged keel engaging elements 61 running in a longitudinal direction along the outer edges of the slot 26 for receiving and engaging the keel 21. The movable elements preferably comprise a surface having a high coefficient of friction against the keel material. The hinged keel engaging elements 61 comprise springs 62 that apply a force that resists opening of the hinged keel engaging elements 61 when the keel 21 engages the hinged keel engaging elements 61. The force applied by the springs 62 secures the device 11 to the keel 21. The keel 21 may be removed by manually pressing the hinged keel engaging elements 61 open wide. Additionally or alternatively, pins 64 at one or both ends of one or both of the hinged keel engaging elements 61 may be configured to hold them in place until removed to release one or both of the the hinged keel engaging elements 61 from the frame 25 or from the locked position.

Battery casings 29a for holding batteries 29 are attached to the frame or housing 25 or may be integral with the housing 25. A motor casing 63 on either lateral side of the frame or housing 25 is attached to, or is integral with, the frame or housing 25 and contains a motor 28 connected to the batteries 29. The motor casing 63 may contain a microprocessor 31 connected one or more motors 28 and one or more of the batteries 29 and may comprise, or be connected to, a receiver or transceiver for one way or two way wireless communication with a remote control device. The interior of the motor casing 63 may be accessed by opening a water tight casing cover 54 that is held closed by a fastener 55, such as a screw or latch and may be configured to allow the passage of a battery 29 into the battery casing 29a. The outward facing lateral side of the microprocessor casing 53 may comprise a threaded bolt hole 42 or other securing means for reversible attachment of an appendage 34. A guide hole 42a may be present to receive a post on the actuator to help align and stabilize the appendage 34. A shaft, axle, socket or post 32 extends from the motor casing 63 to which the simulated animal appendage 34 may be coupled.

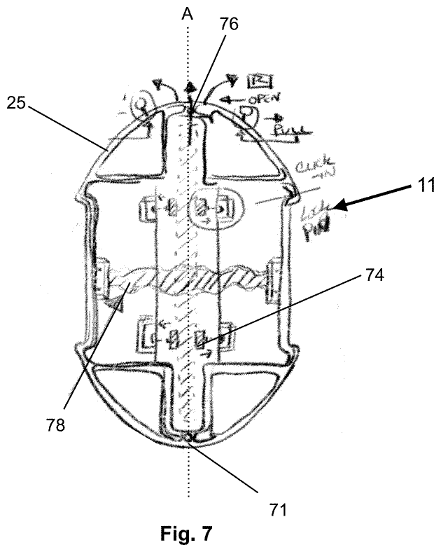

FIG. 7 illustrates yet another alternative embodiment in which the frame or housing 25 comprises a hinge 71 and a latch 76 that allow the frame 25 to be opened and closed in a lateral direction with respect to the frame 25. Additionally or alternatively, the frame may comprise a hinge 71 and latch 76 allowing the frame 25 to open and close along a central axis A running longitudinally (i.e. front to back) in the frame 25. The device 11 may comprise a strap 78 attached tot he frame 25 and configured to wrap over the top of a decoy 10 to hold the device 11 onto the bottom of he decoy 10. Such an arrangement may be particularly advantageous for attaching the device 11 to a decoy lacking a keel 21. For attachment to e keelless decoy, the device may be secured to the bottom of the decoy using an elastic or tensionable strap. Additionally or alternatively, a keel shaped adapter 73 may be attached to the bottom of a keelless decoy and secured to the device 11 as described above. The adapter 73 may comprise attachment means 74 for securing the keel shaped adapter to the bottom of the keelless decoy, such as screws, bolts, clamps, or clasps.

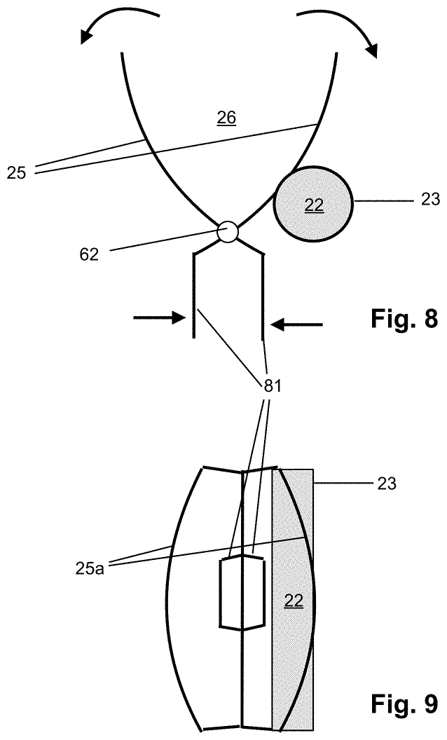

FIGS. 8 and 9 illustrate an embodiment of a motion attachment device comprising a frame 25 with a scissor type movement that is configured to receive a keel 21 in an open position and secure itself to the keel by closing around the keel with a force supplied by a spring loaded hinge 62 that holds the frame 25 closed around the keel. As can be seen in the drawings, the slot 26 in this embodiment is a channel open at both ends but the frame 25 may be configured to provide closed ends when the device is in the closed position, if desired. The frame 25 comprises keel engaging portions 25a that may be shaped to conform to the shape of a keel 21 as shown in the figure. An adapter may be attached to the keel and/or to one or both of the keel engaging portions 25a to accommodate a keel too small to fit snugly in the slot 26. The frame 25 comprises handles 81 that are configured to be gripped in one hand and squeezed together in the direction of the straight arrows in FIG. 8 to open the top of the frame 25 in the direction of the curved arrows to receive the keel. In this embodiment, an actuator 22 comprising a cylindrical casing 23 is attached to the frame. The actuator 22 may be attached at different locations and in different orientations depending on the appendage 34 or propulsion means controlled by the actuator.

A motion attachment device 11 may comprise one or more sensors 67 (FIG. 6a) located in a water tight casing 23, 53, 63 or in a separate water tight casing attached to the frame 25. Sensors 67 may additionally or alternatively be positioned on a decoy 10 attached to the device 11. Examples of sensors 67 that may be attached to the decoy 10 and/or the motion attachment device include temperature sensors, proximity sensors, accelerometers, light sensors, infrared sensors, ultrasonic sensors, and GPS receivers. The sensor preferably comprises, or is connected to, a microprocessor and a transceiver. In use, two or more decoy-motion device combinations may form a game attracting system in which sensors 67 coupled to microprocessors 31 control actuators 22 in such a way as to avoid collisions and/or to coordinate movements of the decoy-motion device combinations to resemble group behaviors of waterfowl on the water. Sensors 67 communicating with RF or IR beacons fixed at positions within sensor range may be used to control the actuators 22 so as to prevent the motion attachment devices 11 from carrying their decoys 10 out of a particular area to avoid entering a particular area.

The frame or housing 25 of a motion attachment device 11 may comprise any number of attachment sites on any exterior surfaces for accessory items to be reversibly attached. Examples of attachment sites may include holes, threaded holes, knobs, protuberances, dimples, and the like. Accessory items may audio speakers, voice boxes, RFID chips, LED indicator lights, GPS Beacons, user interfaces, digital screens, cameras, pole attachments, retractable strings, and weights.

A pole attachment may be used with a motion attachment device 11 and decoy to simulate waterfowl and other game bird movements above the water surface or away from the water. For example, a duck decoy 10 attached to a motion attachment device 11 with attached appendages 34 shaped as wings 36 may be placed on a pole mounted in the shallow bed of a body of water or on the shore of a body of water. The motion attachment device would then be activated to actuate motion of the wings.

The invention is primarily for use with waterfowl decoys but alternative embodiments of the motion attachment device 11 may be configured for use with other types of game birds such as turkeys. Such embodiments may not comprise a slot 26 for receiving a keel and attach directly and reversibly to a turkey decoy. Alternatively, a keel shaped adapter may be fixed to the bottom of a turkey decoy so that keel attachment embodiments of the device may be attached to the decoy. Appendages would, in these embodiments, comprise wings and other simulated bird appendages.

While selected embodiments have been chosen to illustrate the present active decoy motion attachment device, various changes and modifications can be made to the selected embodiments without departing from the scope of the invention as defined in the appended claims. Components that are shown directly connected or contacting each other can have intermediate structures disposed between them. The structures and functions of one embodiment may be adopted in another embodiment and it is not necessary for all advantages to be present in a particular embodiment.

1. A motion attachment device for use with a waterfowl decoy, said device comprising:
a frame comprising a slot configured to receive a keel of the decoy;
securing means for reversibly securing the keel of the decoy in the slot;
a watertight casing containing an actuator comprising an electric motor; and
an appendage reversibly attachable to the frame or the watertight casing and reversibly coupled to the actuator such that, in use, the actuator moves the appendage.

2. The device of claim 1, wherein the watertight casing is an integral part of the frame.

3. The device of claim 1, wherein the watertight casing is reversibly attachable to the frame.

4. The device of claim 1, wherein the device comprises:
two watertight casings, each containing an actuator comprising an electric motor and
two appendages, each reversibly attachable to the frame or the watertight casing and each reversibly coupled to one of the two actuators such that, in use, the actuators move the appendages.

5. The device of claim 1, wherein the watertight casing further contains a microprocessor connected to the electric motor and configured to control a motion of the actuator.

6. The device of claim 1, wherein the frame comprises a hinge allowing two parts of the frame contacting the keel to move relative to one another and thereby change the shape and size of the slot.

7. The device of claim 1, wherein the securing means comprises a clamping means.

8. The device of claim 7, wherein the clamping means comprises a spring loaded hinge that holds the frame closed around the keel.

9. The device of claim 1, wherein the appendage is a simulated wing, a simulated foot, a propeller, a fan, a weight, or a water jet.

10. A kit for imparting a controlled movement to a static decoy, said kit comprising:
the device according to claim 1 and an adapter for adjusting a size or a shape of the slot or an adapter for for adjusting a size or a shape of a keel of the decoy.

11. The kit of claim 10, further comprising a remote control for controlling the operation of the actuator.

12. The kit of claim 10, wherein the kit comprises at least two devices according to claim 1.

13. The kit of claim 12, further comprising two or more sensors reversibly attachable to the at least two devices according to claim 1.

14. A motion attachment device for use with a game bird decoy, said device comprising:
a frame comprising securing means for reversibly securing the decoy to the frame;
a watertight casing containing an actuator comprising an electric motor; and
an appendage reversibly attachable to the frame or the watertight casing and reversibly coupled to the actuator such that, in use, the actuator moves the appendage.

15. The device of claim 14, wherein the appendage is a simulated breast or a simulated wing of a game bird.

16. A kit comprising the device of claim 14 and a remote control for controlling the operation of the actuator.
